(19) United States
(12) Patent Application Publication
(10) Pub. No.: US 2009/0076900 A1
(43) Pub. Date: Mar. 19, 2009

(54) METHOD AND SYSTEM OF FACILITATING THE SALE OF A LEGAL RIGHT TO PERMANENTLY USE PART OF AN OCEAN CRUISER

(76) Inventor: DONALD V. ALLEN, Culver City, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/856,313

(22) Filed: Sep. 17, 2007

(51) Int. Cl. G06Q 30/00

(52) U.S. Cl. 705/14

(57) ABSTRACT

The method of the present invention facilitates the sale of a right to permanently use a portion of an ocean cruiser. The method comprises making an original offer for sale to a purchaser of a right in the ocean cruiser, said right having a first present monetary value. The offer is linked to an offer for sale of a zero coupon bond having a redemption value payable after a certain number of years, said zero coupon bond having a second present monetary value which in a preferred embodiment is equal to the first present monetary value of the share.

### FIELD OF THE INVENTION

This invention addresses the need to overcome problems associated with the sale of a legal right in property in the form of a share in, or a right to permanently use part of, an ocean cruiser. Specifically, the invention provides a method and system of forming a transaction for purchase of a condominium on an ocean cruiser or right to permanently use an ocean liner that provides some guarantee for maintaining the value of the purchase despite depreciation and the ultimate scrapping of the ocean cruiser.

### BACKGROUND OF THE INVENTION

The ocean cruiser industry is a multi-billion dollar industry worldwide and continues to grow rapidly. It is presently in a transitional phase. In the past, the industry was exclusively dominated by luxury ocean cruisers designed and built to take tourists from one port to another, ever changing the passenger list as the cruiser moved from one destination to the next. However, today a significant component of the industry has shifted away from ever changing passenger lists to provide instead a floating home to wealthy global travelers who may purchase a specific set of rooms on a cruiser to serve as a permanent offshore personal condominium. An ocean cruiser of this sort sets sail with a contingent of travelers who own their berths, and who may also, indirectly, own the entire ship through a shareholders' consortium that administers the harboring, provisioning, and navigation of the vessel.

Currently, consortiums that offer ocean cruiser condominiums for sale (or other permanent rights) face a problem not encountered by their land based competitors. Slowly over the years the ocean cruiser will degrade due to wear and tear during life on the salty ocean, and will unavoidably become unseaworthy to a point where it will have to be confined to a dock, or scrapped. This period is today typically about fifty years based on the present state of technology. At such a stage, the value of a condominium on a vessel will be zero, or close to zero. This is a major drawback for entrepreneurs who develop and build ocean going cruisers for sale as floating condominiums to wealthy customers. Anybody who has sufficient wealth to consider purchasing a seagoing condominium will realize that, over his or her expected tenancy of the condominium, its value will decline—perhaps to zero—compared with a purchase price of around $2 million in current currency. Compared with this, one who invests in a land based condominium will typically find its value has increased over the same period.

Accordingly, there is a need in the art of ocean cruiser development and construction to provide a method and system that provides some guarantee of substantial residual value in the purchase of a legal right to permanently use part of an ocean cruiser, or shares in the cruiser, when such right is eventually sold or alienated. The present invention addresses these and other needs.

### SUMMARY OF THE INVENTION

In a preferred embodiment there is described a system and method for facilitating sale of a right to permanently use a portion of an ocean cruiser. Because various types of legal ownership of rights in an ocean cruiser are contemplated by this invention, the term “right to permanently use a portion of an ocean cruiser” will be interpreted herein to include schemes whereby a purchaser may buy a specific set of rooms in an ocean cruiser, to purchasing shares in an ocean cruiser with rights to control decisions about the disposition of the vessel, or schemes which are a combination of these legal rights.

The method comprises making an original offer for sale to a purchaser of a right to permanently use a portion of an ocean cruiser, in which the right has a first present monetary value. The offer is then linked to an offer for sale of a zero coupon bond having a redemption value payable after a certain number of years, in which the zero coupon bond has a second present monetary value. If the offer is accepted, the sale of the right in the ocean cruiser and the zero coupon bond is executed in a transaction with the purchaser. In this way, the purchaser is assured that he will redeem a substantial proportion of his purchase price upon the eventual retirement of the vessel from service, or upon the sale of his or her right to a subsequent purchaser.

In a further aspect of the invention, the right in the ocean cruiser includes rights to exclusive enjoyment of a condominium on the ocean cruiser, and the certain number of years is substantially equal to the life expectancy of the ocean cruiser. In a preferred aspect, the redemption value of the zero coupon bond is at least equal to the first present monetary value of the share of the ocean cruiser. This aspect provides some assurance that the proportion of the purchase price recovered upon sale or retirement of the vessel will be substantial.

In yet a further aspect of the invention, the method further includes the original purchaser subsequently selling the right and the bond to a subsequent purchaser, wherein the combined monetary value of the right and the bond at the time of the subsequent sale is not less than 67% of the combined first and second monetary values at the time of the original sale.

For a fuller understanding of the nature and objects of the invention, reference should be made to the following detailed description taken in connection with the accompanying drawings.

### BRIEF DESCRIPTION OF THE FIGURES

For a fuller understanding of the nature and objects of the invention, reference should be made to the accompanying drawings, in which:

FIG. 1 is a diagram showing aspects of the present invention.

FIG. 2 is a diagram showing aspects of the present invention.

FIG. 3 is a flow chart showing aspects of the method of the present invention.

### DESCRIPTION OF THE PREFERRED EMBODIMENT

With reference to the Figures, which are provided by way of exemplification and not limitation, there is described a method and system having features of the present invention. One component of the invention is a known financial instrument described as a “zero coupon bond.” A zero coupon bond is a security that pays no interest during the term of the bond, but the holder receives the rate of return through the gradual appreciation of the security, which is redeemed at maturity for the full value on the face of the security. Accordingly, it will be appreciated that a zero coupon bond is sold at a deep discount from face value. The amount of the discount depends on the interest rate, whereby the greater the interest the greater the discount, and therefore the lower the purchase price. The lower the interest rate the lower the discount, and therefore the higher the purchase price.

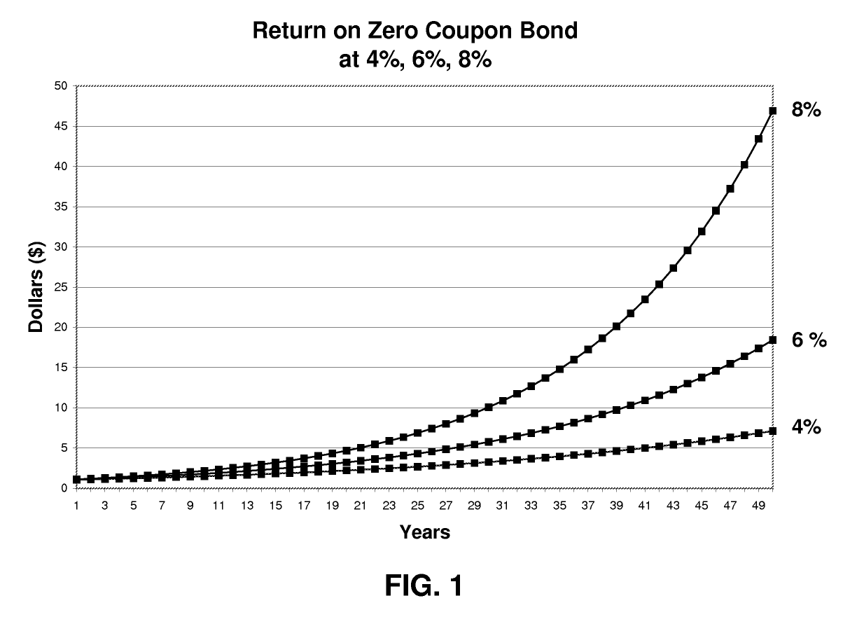

Thus, it may be seen, with reference to FIG. 1, a zero coupon bond purchased for $1.00 at 8% for a period of 50 years will pay $47 on the 50^{th} year. At 6% it will pay $19 and at 4% it will pay $7. As a practical matter, it can therefore be seen that a bond having a redemption face value of $2 million after 50 years can be purchased, at 8% interest, for about $0.042 million; at 6% the same can be purchased for about $0.105 million; and at 4% it can be purchased for about $0.285 million.

As a matter of detail, it may be noted that zero coupon bonds for 50 years are not at this time freely available on the open money market, the maximum period of a US Government issued zero coupon bond being typically 30 years. However, it will readily be understood that, at the expiration of a 30 year bond, a further 20 year bond may be purchased with the redemption payment of the initial 30 year bond, thus providing the same result as if a 50 year bond had been purchased. Alternatively, two 25 year bonds may be purchased end-to-end for the same result, or similar variations to produce the same result.

Turning now to a novel feature of the present invention, the figures and concepts described above show that, if a seller of a right to permanently use a portion of an ocean cruiser (which may include exclusive rights to use a condominium on such cruiser) valued at about $2 million adds about 10-15% to the purchase price, that purchase price can be substantially returned to the purchaser in 50 years time if the purchase is linked, or bundled, with the additional acquisition for the benefit of the purchaser of a zero coupon bond having a redemption value of $2 million. Thus, in accordance with the present invention, the seller offers to sell the purchaser a package of both a right to permanently use a portion of an ocean cruiser and a zero coupon bond having a term that substantially equals the life expectancy of the ocean cruiser. If the purchaser accepts this bundled offer, the purchaser will substantially recover his or her purchase price through redemption of the bond when the ocean cruiser is retired from service on the high seas. This sale of both a right to permanently use a portion of an ocean cruiser and a zero coupon bond is a feature of the present invention and provides an advantage over present methods and systems of sale and purchase of shares or rights in an ocean cruiser, in which the purchaser eventually loses his entire purchase price when the ocean cruiser is eventually retired.

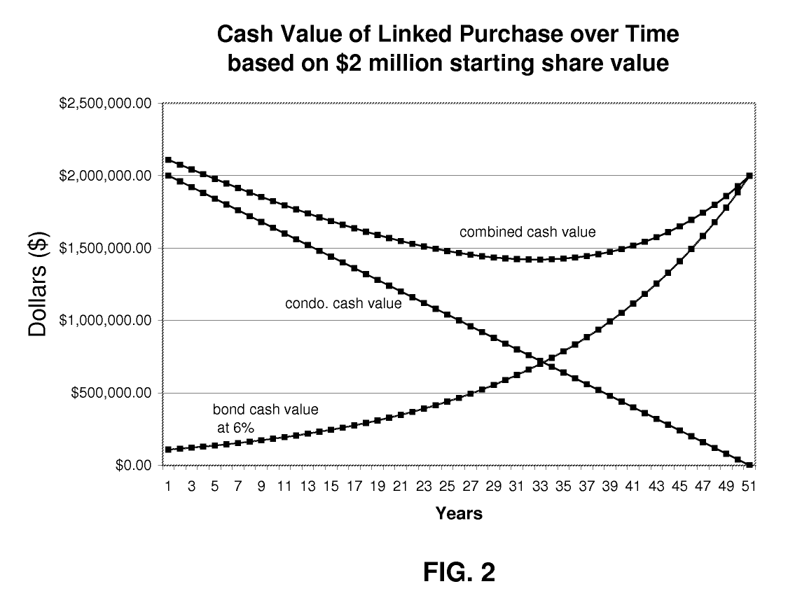

Turning now to further advantages, the method of the present invention is sufficiently flexible that the same advantage provided to the original purchaser of a right to permanently use a portion of an ocean cruiser may be passed along to subsequent purchasers. This may be seen with reference to FIG. 2, which exemplifies how the value of a condominium on an ocean cruiser may decline over a 50 year period, while at the same time the value of a 50 year bond at 6% will increase over the same period, with the sum of the two values remaining within 33% of the initial purchase price of the combined share and bond, before increasing to almost full cash value. In this example, the bond cash value at 6% is shown, increasing over time. This is the value of the bond to the owner as a function of time. It will be understood that, as the redemption date on the bond approaches, the purchase value of the bond will increase, so that just before the redemption date its cash value approaches its face value. The cash value of the right, or condominium, on the other hand, may experience a gradual linear decline as the expiration date of the cruise cruiser approaches. Just before the expiration date, its value approaches zero. However, when the two cash values are combined, it is seen that the combined cash value falls initially by an insubstantial amount but remains within about 33% of the original combined purchase price, in other words, the value does not diminish below 67% of the original purchase price at this interest rate on the bond.

This substantial retention in value of the combined purchase of a right to permanently use a portion of an ocean cruiser and a zero coupon bond may be relied upon by the owner of the same when he or she wishes to sell. The subsequent purchaser after a certain number of years since the original purchase pays the original purchaser, for example, the amount shown on the upper line in FIG. 2 where the prevailing interest rate is for example 6%. Thus, the subsequent purchaser acquires both a share in the ocean cruiser which has declined in value since the original purchase, and the entire remaining value of the zero coupon bond which, by this time, has increased in value. In this way, the original purchaser recovers a substantial portion of his original investment, and the subsequent purchaser acquires a bundled sale that, in its turn, includes a component that will assure that the subsequent purchaser is not left without any cash value when he may sell it to yet a further purchaser, or the ocean cruiser is eventually retired from service. In this way, the present invention creates a liquidity in the market for shares of an ocean cruiser in circumstances where liquidity would otherwise be “sticky,” as a result of declining asset value.

It will be appreciated that the above example merely describes a principle of the invention, and that details will differ in different circumstances. For example, if the interest rate changes after the original purchase but before the bond redemption date, the cash value of the bond will change from what it would have been if the interest rate had not changed. However, the same principle as described above will continue to apply, and the purchaser will find that the combined value of his purchase will retain a substantial proportion of its cash value when purchased.

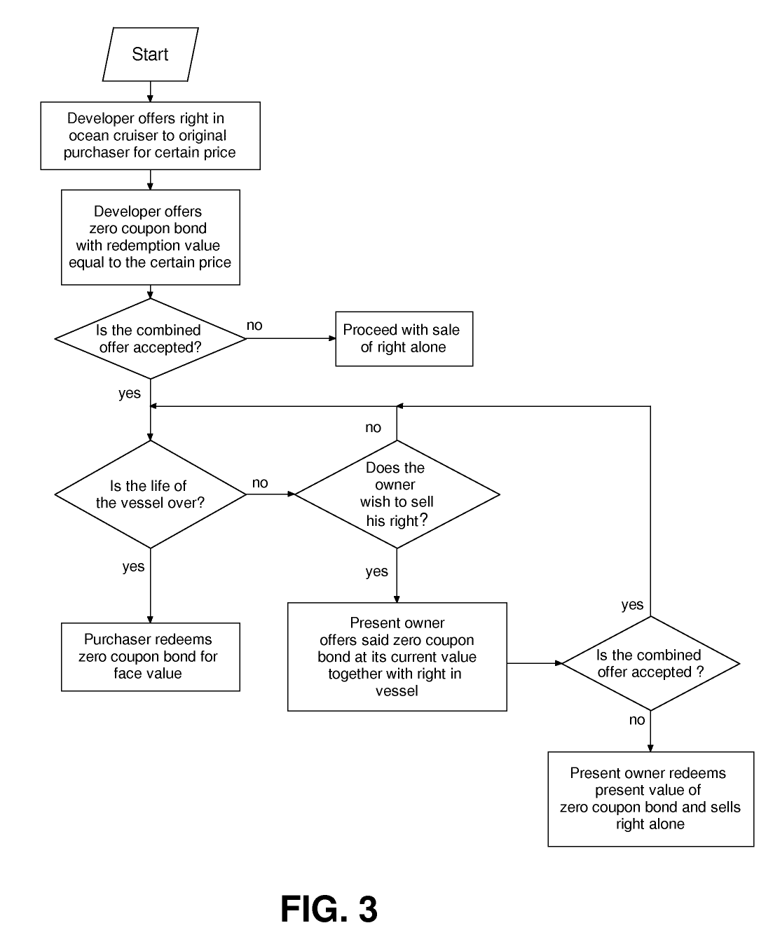

Turning now to FIG. 3, the principle of the present invention as described above is demonstrated in the form of a flow chart, in that any sale of a right to permanently use a portion of an ocean is bundled with the sale of a zero coupon bond for redemption upon sale of the right or upon retirement of the vessel. In the first sale, the face value of the zero coupon bond is chosen to be equal to or near the purchase price of the condominium (or rights in the ocean cruiser), and the price of the zero coupon bond is determined by market prices for such bond based on the interest rate and the amount of time remaining before payment on the bond becomes due. For example, if the price of the condominium is $2.0 million dollars, the face value of the zero coupon bond will be chosen to be $2 million dollars. Any subsequent sale of the condominium may be accompanied by the bundled sale of the same zero coupon bond to the new purchaser, according to the principles set forth above.

Thus it will be seen that the present invention satisfies needs found in the prior art for maintaining cash value in a share of an ocean cruiser that is destined, ultimately, for the scrap yard. It will be realized that the foregoing preferred specific embodiments have been shown and described for the purpose of illustrating the functional and structural principles of this invention and are subject to change without departure from such principles. Therefore, this invention includes all modifications encompassed within the spirit and scope of the following claims.

We claim:

1. A method for facilitating sale of a right to permanently use a portion of an ocean cruiser comprising:
making an original offer for sale to a purchaser of said right, said right having a first present monetary value;
linking to the original offer for sale of said right a zero coupon bond having a redemption value payable after a certain number of years, said zero coupon bond having a second present monetary value; and
executing the sale of said right and said zero coupon bond in a transaction with the purchaser.

2. The method of claim 1 wherein said right includes exclusive permanent enjoyment of a condominium on the ocean cruiser.

3. The method of claim 1 wherein said certain number of years is substantially equal to the life expectancy of the ocean cruiser.

4. The method of claim 1 wherein the redemption value of said zero coupon bond is at least equal to the first present monetary value of said right.

5. The method of claim 1, further including the purchaser subsequently selling both said right and said bond to a subsequent purchaser, wherein the combined monetary value of said right and said bond at the time of the subsequent sale is not less than 67% of the combined first and second monetary values at the time of the original sale.
